(19) United States
(12) Patent Application Publication
(10) Pub. No.: US 2026/0050784 A1
(43) Pub. Date: Feb. 19, 2026

(54) Nonlinear Quantization of Weights for Analog Compute Modules to Accelerate Multiplication and Accumulation Operations

(71) Applicant: Micron Technology, Inc., Boise, ID (US)

(72) Inventors: Febin SUNNY, Folsom, CA (US); Poorna KALE, Folsom, CA (US)

(21) Appl. No.: 18/733,719

(22) Filed: Jun. 4, 2024

Related U.S. Application Data
(60) Provisional application No. 63/507,227, filed on Jun. 9, 2023.

(51) Int. Cl. G06N 3/082; G06N 3/049; G06N 3/0495; G06N 3/065

(52) U.S. Cl. CPC G06N 3/082; G06N 3/049; G06N 3/0495; G06N 3/065

(57) ABSTRACT

Techniques of nonlinear quantization of an artificial neural network model having first weights. For example, a predetermined number of unique, second weights having a nonlinear distribution in a weight space of the first weights can be identified to generate a quantized model based on replacing, in the artificial neural network model, the first weights with closest ones from the second weights. A linear mapping between the second weights and values of conductance of memristors of an accelerator configured to perform operations of multiplication and accumulation can be used to determine the same predetermined number of programming voltages. Conductance of the memristors can be programmed using the programming voltages in preparation of the accelerator to perform an operation of multiplication and accumulation in the quantized model. The nonlinear distribution and the linear mapping can be adjusted to increase or optimize the accuracy of the quantized model.

### RELATED APPLICATIONS

The present application claims priority to Prov. U.S. Pat. App. Ser. No. 63/507,227 filed Jun. 9, 2023, the entire disclosures of which application are hereby incorporated herein by reference.

### TECHNICAL FIELD

At least some embodiments disclosed herein relate to acceleration of multiplication and accumulation operations using memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

### BRIEF DESCRIPTION OF THE DRAWINGS

The embodiments are illustrated by way of example and not limitation in the figures of the accompanying drawings in which like references indicate similar elements.

FIG. 1 shows a technique to quantize the weights of an artificial neural network model based on a set of representative weights having a nonlinear distribution in the weight space according to one embodiment.

FIG. 2 illustrates the optimization of a quantized model having a predetermined number of representative weights according to one embodiment.

FIG. 3 shows the mapping between representative weights and voltages to program a memristor to have the representative weights of a nonlinear distribution according to one embodiment.

FIG. 4 shows the programming of a memristor crossbar array to implement multiplication and accumulation operations of a quantized model according to one embodiment.

FIG. 5 shows a memristor crossbar array of an analog compute module to implement multiplication and accumulation operations of a quantized model according to one embodiment.

FIG. 6 shows a method of implementing the computations of an artificial neural network in an analog compute module according to one embodiment.

### DETAILED DESCRIPTION

At least some embodiments disclosed herein provide techniques of nonlinear quantization of weights implemented using conductance of memristors of an analog compute module to accelerate operations of multiplication and accumulation of the weights (e.g., in an artificial neural network).

In some applications, it can be desirable to perform a quantization operation of replacing a large number of different weights used in an artificial neural network (ANN) model with a small, predetermined number of representative weights. When being limited to the use of weights selected from the small set of representative weights, the quantized version of the artificial neural network (ANN) model can use space for storage and less communication bandwidth for transmission and can, in some implementations, simplify the computations involving the weights.

During the quantization of the original weights of an artificial neural network (ANN) model, the entire set of different weights used in the model can be replaced with, and thus approximated by, the closest weights selected from a small set of representative weights. Each original weight in the model can be rounded to a closest representative weight in the representative weight set. The rounding of original weights to their closest representative weights introduces errors and thus inaccuracy.

In at least some embodiments disclosed herein, representative weights of a nonlinear distribution are used to quantize the weights of an artificial neural network (ANN) model. The representative weights are unevenly distributed within the entire range of possible weights in the weight space. Thus, the gaps between adjacent representative weights can be non-uniform.

The weights of a typical artificial neural network (ANN) model have an uneven distribution of incident rates. Typically, there are more weights in the middle range than in the lower ranger and in the upper range. However, the accuracy of the weights in the lower range and the upper range can be more important to the overall accuracy of the artificial neural network (ANN) model than the weights in the middle range.

For example, more representative weights can be allocated to the lower weight range and the upper weight range than to the middle weight range. For example, representative weights can be configured to be more densely populated in the lower and upper weight ranges than in the middle weight range. For example, the gaps between adjacent representative weights can be bigger in the middle range than in the lower and upper ranges.

As a result, the accuracy in quantization of weights can be higher for the lower and upper ranges than for the middle range; and the rounding errors in approximating original weights of the artificial neural network (ANN) model using representative weights from the small weight set can be lower in the lower and upper weight ranges than in the middle weight range.

Optionally, the selection of the representative weights for quantization can be adjusted to change the accuracy level of the quantized model; and the changes can be explored to arrive at a set of representative weights that improve or optimize the overall accuracy of the quantized model.

When a number of representative weights are evenly spaced, the rounding errors resulting from the use these representative weights can be substantially evenly distributed across the range of these representative weights. The rounding errors are limited by the gap between the adjacent representative weights.

Since the weights in the lower and upper ranges of weights can be more important to the overall accuracy of the artificial neural network (ANN) model, the representative weights can be configured to have a smaller gap in the lower and upper ranges to reduce the rounding errors for quantization of weights in the lower and upper ranges. In contrast, the representative weights can be configured to have a larger gap in the middle range to allow larger rounding errors for quantization of weights in the middle range than for the lower and upper ranges.

For example, the weight range of the artificial neural network (ANN) model can be divided into a lower range, a middle range, and an upper range. A lower threshold can be selected to separate the lower range from the middle range; and an upper threshold can be selected to separate the middle range from the upper range. A predetermined number of representative weights can be allocated for even distribution within the middle range; and the remaining representative weights can be allocated for even distribution within the upper and lower range. Thus, the size of gaps between adjacent representative weights in the middle range is generally different from the size of gaps between adjacent representative weights in the lower and upper ranges. Adjusting the thresholds can change the gap sizes and thus the ratio between the gap size for the middle region and the gap size for the lower and upper ranges. The ratio is representative of the accuracy difference in quantization for the middle range and for the lower and upper ranges. The adjustment of the ratio can be used in searching for a set of representative weights for quantization that can improve or optimize overall accuracy level for the quantized model.

In general, the optimization of the quantized model does not have to be limited to a particular pattern of organizing the representative weights. For example, it is not necessary to evenly distribute, within the middle region, the number of representative weights allocated to the middle region. For example, it is not necessary to maintain a same size of gaps between adjacent representative weights for the lower range and for the upper range. Optionally, restrictions in implementing the weights in a compute module (e.g., via conductance of memristors) can be included in selectively positioning the representative weights.

After the weight quantization, the weights in the quantized model can be represented using the indexes of the representative weights as in a representative weight list. For example, when eight (8) representative weights are used to quantize the artificial neural network (ANN) model, each weight in the model can be converted into a three-bit index of a closest representative weight among the eight (8) representative weights. When a nonlinear distribution of representative weights is used, the weight indexes cannot be converted to the representative weights via a linear mapping. A look up table can be used to determine the representative weight identified via a weight index.

When the multiplication and accumulation operations of the quantized model are accelerated via an analog compute module implemented using a memristor crossbar, the weights can be represented using the conductance of the memristors.

For example, a linear mapping between weight and memristor conductance can be used to implement the weights via conductance of memristors. Since conductance of memristors is configured to be proportional to the respective weights, multiplication of the weights can be proportional to multiplication of memristor conductance, as in the relation between current going through a memristor and the conductance of the memristor. The current is equal to the multiplication of the memristor conductance by an input voltage applied to the memristor.

A memristor can have a conductance voltage curve that identifies the relation between a voltage level applied to program the memristor and the resulting conductance of the memristor. Thus, for each conductance value used to implement a representative weight, a programming voltage can be determined from the conductance voltage curve. Therefore, the list of representative weights can have a list of programming voltages for their implementation via the memristor. An index to select a weight from the weight list can also be used to select a programming voltage to implement the weight via programming the conductance of the memristor.

In some implementations, the use of programming voltages to achieve desirable conductance can have challenges in certain regions of conductance and/or programming voltages. For example, selectable programming voltages can be limited; and such restriction can affect the selection of representative weights for quantization of the artificial neural network model. For example, programming voltages that can be generated to program a memristor can have a limited resolution (e.g., based on steps of incremental voltages that can be generated, resolution of digital to analog converters to apply programming voltages). Thus, different programming voltages can have different accuracy levels in producing desirable memristor conductance. The optimization of the quantized model can be performed with such restrictions and/or with optimization to reduce or minimize such inaccuracy.

The overall accuracy of the quantized model can be evaluated based on a set of test inputs. For example, the output of the artificial neural network (ANN) model responsive to a test input can be compared with the corresponding output of the quantized model to evaluate the accuracy of the quantized model. The selection of the representative weights for quantization can be adjusted to minimize the differences between the outputs of the artificial neural network (ANN) model and the outputs of the quantized model for the set of test inputs.

Optionally, the outputs of the quantized model can be generated from implementing the multiplication and accumulation of the weights through the memristors in the analog compute module to account for not only the errors in weight quantization but also the errors in weight implementation through memristor conductance. The outputs of the artificial neural network (ANN) model can be computed using alternative accelerators (e.g., implemented via logic circuits) or using microprocessors (e.g., graphical processing units) to achieve high accuracy.

Optionally, a set of training data can be used to further train the quantized model to improve the accuracy of the quantized model. In some implementations, the training of the quantized model is configured to both identify weights for artificial neurons, limited to a set of representative weights, and identify the representative weights in the set, through reduction of the errors in making predictions according to the training data.

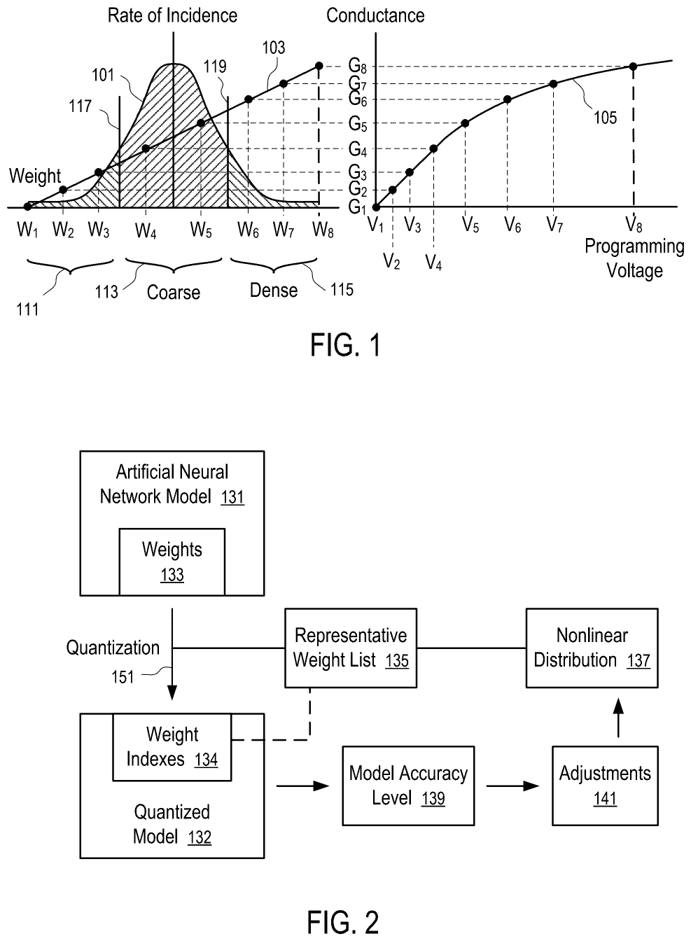

FIG. 1 shows a technique to quantize the weights of an artificial neural network model based on a set of representative weights having a nonlinear distribution in the weight space according to one embodiment.

In FIG. 1, the weights of the artificial neural network (ANN) model has a distribution curve 101 of rate of incident. A typical weight (e.g., W4 or W5) in a middle range has a high rate of incidence. A typical weight (e.g., W2 or W7) in the lower and upper ranges has a low rate of incident.

A lower threshold 117 and a higher threshold 119 can be used to divide the ranges of weights into three regions. A lower range 111 contains the weights smaller than the lower threshold 117; an upper range 115 contains the weights larger than the higher threshold 119; and a middle range 113 contains the weights that are between the lower threshold 117 and the higher threshold 119.

FIG. 1 illustrates the use of eight representative weights W1 to W8 for the quantization of the weights having the distribution curve 101. In general, more or less representative weights can be used. Thus, the technique is not limited to the use of a particular number of representative weights in quantization.

Since the accuracy of the weights in the lower range 111 and the upper ranges 115 are generally more important, more representative weights are allocated and distributed to the lower range 111 and the upper range 115 than to the middle range 113.

The inter-weight gaps between the adjacent representative weights (e.g., W5-W4) in the middle range 113 are configured to be larger than the inter-weight gaps (e.g., W2-W1, W3-W2, W7-W6, W8-W7) in the lower range 111 and the upper range 115. Thus, the population of representative weights is configured to be relatively coarse in the middle range 113; and the population of representative weights is configured to be relatively dense in the lower range 111 and the upper range 115.

For example, the representative weights (e.g., W4 and W5) allocated to the middle range 113 can be evenly distributed in the middle range 113 with an inter-weight gap that is equal to the difference between the two thresholds (which is equal to the size of the middle range 113) divided by the number of representative weights allocated to the middle range 113.

For example, the representative weights (e.g., W1, W2, and W3) allocated to the lower range 111 can be evenly distributed in the lower range 111 with an inter-weight gap that is equal to the size of the lower range 111 divided by the sum of −0.5 and the number of representative weights allocated to the lower range 111.

Similarly, the representative weights (e.g., W6, W7, and W8) allocated to the upper range 115 can be evenly distributed in the upper range 115 with an inter-weight gap that is equal to the size of the upper range 115 divided by the sum of −0.5 and the number of representative weights allocated to the upper range 115.

Optionally, the upper range 115 and the lower range 111 can be configured, via the selection of thresholds 117 and 119 to have a same size. Optionally, the upper range 115 and the lower range 111 can be configured to have a same inter-weight gap.

When the representative weights are distributed according to a pattern as described above, the locations of the representative weights (e.g., W1 to W8) can be determined from one or more parameters, such as the lower threshold 117 and the higher threshold 119. The adjustments of the locations of the representative weights in the weight space can be controlled via the adjustments to the parameters. Optionally, the locations of the representative weights in the weight space can be individually adjusted to maximize the flexibility in optimizing the overall accuracy of the quantized model.

Since the representative weights are not uniformly distributed across the entire range of weights, there is no linear mapping that can be used to map the indexes of the weights to their respective locations in the weight space.

For the given locations of the representative weights, each weight used in the artificial neural network can be replaced by (and thus rounded to) a closest one of the representative weights. The rounding errors are generally higher for the weight ranges having a larger inter-weight gap and lower for the weight ranges having a smaller inter-weight gap.

The representative weights (e.g., W1 to W8) can be represented by the conductance of a memristor in an analog compute module for performance of multiplication and accumulation involving a weight.

FIG. 1 further shows an example of a conductance voltage curve 105. For a given programming voltage used to program the conductance of the memristor, the curve 105 identifies a resulting conductance that the memristor has after the programming operation.

The conductance voltage curve 105 can be used to determine a programming voltage usable to program a memristor to have a conductance to implement a representative weight in multiplication and accumulation computation.

For example, a linear mapping 103 can be used to map the range of representative weights (e.g., W1 to W8) to a range of conductance (e.g., G1 to G8). The order of the linear mapping 103 and a multiplication and accumulation operation can be changed without affecting the result. Thus, the multiplication and accumulation operation involving the weights can be performed by applying the multiplication and accumulation operation to the corresponding conductance and then applying the linear mapping 103 to obtain the result of the multiplication and accumulation operation being applied to the weights.

For example, to implement a representative weight W4 (W2 or W7), the correspond conductance G4 (G2 or G7) as identified by the linear mapping 103 can be used. To program a memristor to have the corresponding conductance G4 (G2 or G7), the corresponding programming voltage V4 (V2 or V7) can be applied.

In general, different regions of programming voltages can have different accuracy levels in achieving the programmed conductance of the memristors. For example, a same amount of variation in the applied programming voltage can cause different amounts of variations in the resulting conductance and thus the weight represented by the conductance. Optimization of the overall accuracy of the quantized model can be performed to account for not only rounding inaccuracy in quantization, but also the inaccuracy in the programming of the conductance of memristors to implement the representative weights.

By adjusting the mapping 103 and the locations of the representative weights in the weight space, the resulting quantized model can have improved and/or optimized accuracy performance.

FIG. 2 illustrates the optimization of a quantized model having a predetermined number of representative weights according to one embodiment.

For example, the optimization of FIG. 2 can be implemented based on the use of the technique of FIG. 1.

In FIG. 2, an artificial neural network model 131 has a large number of different weights 133. The weights 133 can have rates of incidence according to the distribution curve 101 in FIG. 1.

A set of representative weights (e.g., W1 to W8) having a nonlinear distribution 137 (e.g., as in FIG. 1) can be identify so that the weights in the lower range 111 and the upper range 115 have smaller rounding errors than the weights in the middle range 113.

During the operation of quantization 151, each of the weights 133 is substituted by a weight index 134 of its closest representative weight in the list 135 of representative weights (e.g., W1 to W8). Thus, the weights 133 are approximated with the representative weights (e.g., W1 to W8) identified by the weight indexes 134. Quantization 151 reduces the storage size of the quantized model 132, but degrades the accuracy level 139 of the quantized model 132.

The nonlinear distribution 137 of the list 135 of the representative weights (e.g., W1 to W8) can be adjusted to change the model accuracy level 139. Adjustments 141 can be explored to search for a nonlinear distribution 137 that improves the accuracy level 139.

For example, when the locations of the representative weights (e.g., W1 to W8) are controlled by the thresholds 117 and 119, the thresholds 117 and 119 can be adjusted to change the nonlinear distribution 137. A change that leads to improvement in the model accuracy level 139 can be accepted; and a change that leads to degradation in the model accuracy level 139 can be reversed.

The accuracy level 139 of the quantized model 132 can be evaluated by comparing the outputs generated by the quantized model 132 and the outputs generated by the original artificial neural network (ANN) model 131.

For example, the computations of the original artificial neural network (ANN) model 131 responsive to a set of inputs can be performed using a computing system to generate a set of outputs. The computations of the quantized model 132 responsive to a same set of inputs can be performed using the computing system to generate another set of outputs. For example, the computing system can be configured to implement the weights in a digital form (e.g., processed using logic circuits without losing accuracy).

Thus, the differences between the sets of outputs are the result of replacing the original weights 133 with the closest representative weights in the list 135. The differences can be measured to generate an indicator of the accuracy level 139. The adjustments can be performed to reduce or minimize the differences.

Optionally, instead of using the same computing system to perform the computations of the quantized model 132, a computing system configured to accelerate multiplication and accumulation operations in an analog form using memristors can be used to generate the outputs of the quantized model 132. For example, the representative weights (e.g., W1 to W8) can be implemented in computations via respective conductance (e.g., G1 to G8) achieved through applying programming voltages (e.g., V1 to V8). Thus, the different between the sets of outputs are the result of replacing the original weights 133 with the closest representative weights in the list 135 implemented through programming voltages applied to memristors. The differences can be measured to generate an indicator of the accuracy level 139. The adjustments can include the changes of the locations of the representative weights in the weight space and the linear mapping 103 to reduce or minimize the differences caused not only by the quantization 151 but also by the programming of memristor conductance.

Optionally, a training dataset is further used to train the quantized model 132 by adjusting the weight indexes 134 and the representative weights (e.g., W1 to W8) in the list 135.

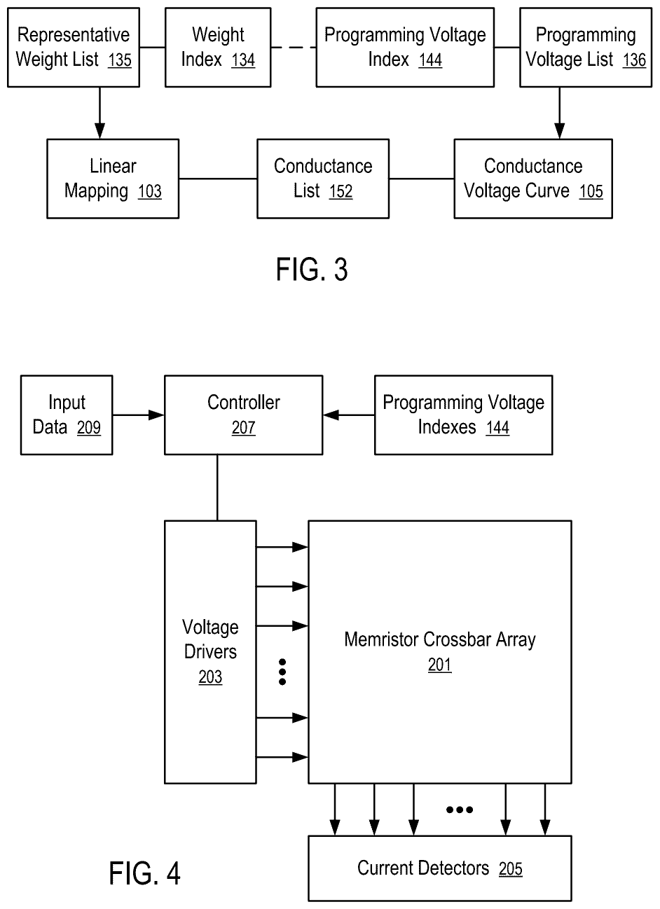

FIG. 3 shows the mapping between representative weights and voltages to program a memristor to have the representative weights of a nonlinear distribution according to one embodiment.

In FIG. 3, a list 135 of representative weights (e.g., W1 to W8) for quantization 151 in FIG. 2 can be mapped to a list 152 of conductance values (e.g., G1 to G8) using a linear mapping 103 (e.g., as illustrated in FIG. 1). Adjusting the linear mapping 103 can map the range of representative weights (e.g., W1 to W8) to different regions of the conductance voltage curve 105. Implementing the same list 135 of representative weights (e.g., W1 to W8) using different regions of the conductance voltage curve 105 can result in different accuracy levels 139 of running the quantized model 132 using an accelerator that is configured to use memristor conductance to implement weights in multiplication and accumulation computations.

In FIG. 3, the list 152 of conductance values (e.g., G1 to G8) can be mapped to a list 136 of programming voltages (e.g., V1 to V8) using a conductance voltage curve 105 (e.g., as illustrated in FIG. 1).

After the determination of the list 136 of programming voltages (e.g., V1 to V8), a weight index 134 (e.g., 2 or 4) identifying a representative weight (e.g., W2 or W4) in the list 135 can be implemented via programming a memristor having the conductance voltage curve 105. For example, the weight index 134 (e.g., 2 or 4) can be used as the corresponding programming voltage index 144 (e.g., 2 or 4) to determine, from the programming voltage list 136, a programming voltage (e.g., V2 or V4). When the memristor is programmed using the programming voltage (e.g., V2 or V4), the memristor has a conductance value (e.g., G2 or G4) that implements the representative weight (e.g., W2 or W4).

In some implementations, the linear mapping 103 is incorporated into the quantized model 132. Thus, the results of multiplication and accumulation applied to conductance values can be used directly in subsequent computations (e.g., evaluation of activation functions).

In some implementations, the linear mapping 103 is used to convert the results of multiplication and accumulation applied to conductance values into multiplication and accumulation applied to representative weights (e.g., W1 to W8), before being used in subsequent computations (e.g., evaluation of activation functions).

FIG. 4 shows the programming of a memristor crossbar array to implement multiplication and accumulation operations of a quantized model according to one embodiment.

For example, the multiplication and accumulation operations as applied to the weights 133 of an artificial neural network (ANN) model 131 can be implemented as multiplication and accumulation operations on representative weights in the list 135 for a respective quantized model 132 of FIG. 2 using a memristor crossbar array 201 of FIG. 4.

In FIG. 4, a controller 207 is configured (e.g., via a logic circuit and/or instructions) to use voltage drivers 203 to apply voltages to the memristor crossbar array 201.

To prepare the memristor crossbar array 201 for multiplication and accumulation operations, the controller 207 uses the voltage drivers 203 to apply programming voltages onto memristors in the crossbar array 201 to change, and thus program, the conductance values of the memristors.

For example, when a memristor in the array 201 is to have a conductance value to implement a representative weight having a weight index 134 in the weight list 135, the controller 207 can use a corresponding programming voltage index 144 to identify a programming voltage in the programming voltage list 136 (e.g., as in FIG. 3). The controller 207 can instruct the voltage drivers 203 to apply the programming voltage to the memristor in the array 201 such that after the programming operation, the conductance of the memristor has a corresponding value in the conductance list 152 corresponding to the representative weight list 135.

After the memristors in the array 201 are programmed to have conductance values representative of the representative weights of a matrix in the quantized model 132, the controller 207 can use the voltage drivers 203 to drive input voltages onto wordlines in the array 201 according to the input data 209 to be applied to the matrix. For example, the input voltages can be proportional to the data elements in the input data 209.

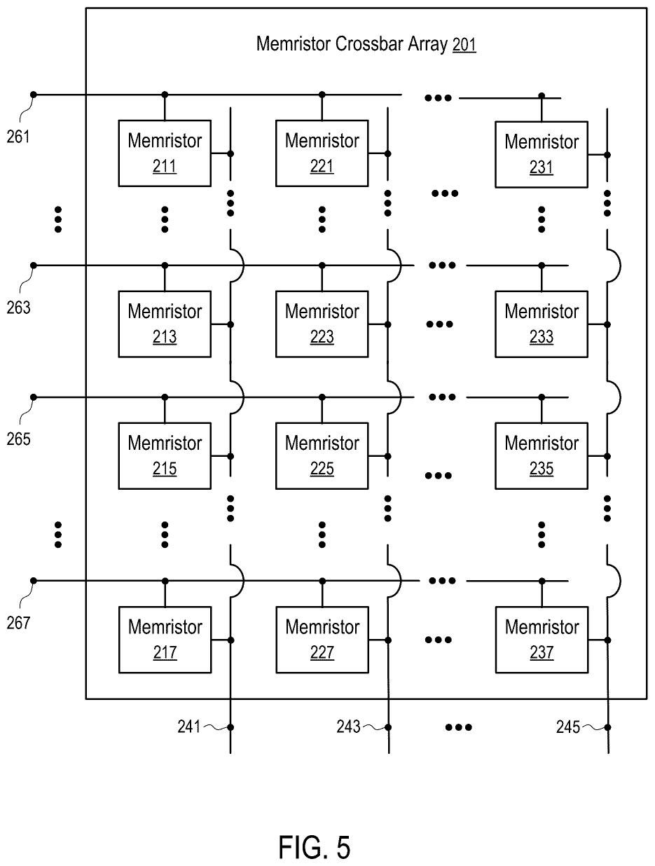

Bitlines in the memristor crossbar array 201 are configured to collect currents going through respective columns of memristors in the array 201. The current detectors 205 are configured to measure the currents collected into the bitlines. The amount of current going through a memristor is equal to the multiplication of the conductance value of the memristor by the input voltage applied to the memristor. The amount of current collected by a bitline is equal to the sum of currents going through a column of the memristors in the array 201. Thus, the current measured by a current detector 205 on a bitline corresponds to the result of multiplication and accumulation of the conductance values by a column of memristors in the array 201 with the input voltages applied according to the input data 209, as further illustrated and discussed in connection with FIG. 5.

FIG. 5 shows a memristor crossbar array of an analog compute module to implement multiplication and accumulation operations of a quantized model according to one embodiment. For example, the memristor crossbar array 201 of FIG. 4 can be implemented in a way as illustrated in FIG. 5.

In FIG. 5, each of the memristors in the crossbar array 201 is connected between a wordline (e.g., 261) and a bitline (e.g., 241). A pair of voltage drivers (e.g., among voltage drivers 203 in FIG. 4) connected to the wordline (e.g., 261) and the bitline (e.g., 241) can be instructed or controlled by a controller (e.g., 207 in FIG. 4) to apply a programming voltage (e.g., V2 or V4 in FIG. 1) to a memristor (e.g., 211) in programming the conductance of the memristor (e.g., 211) to a value (e.g., G2 or G4 in FIG. 1) to implement a respective representative weight (e.g., W2 or W4 in FIG. 1) used in a quantized model (e.g., 132 in FIG. 2).

During the operations of multiplication and accumulation, the wordlines 261, . . . , 263, 265, . . . , 267 are configured to receive input voltages (e.g., generated according to input data 209 in FIG. 4); the bitlines 241, 243, . . . , 245 are configured to provide output currents to current detectors (e.g., 205 in FIG. 4); and the memristor crossbar array 201 can generate output currents on the bitlines 241, 243, . . . , 245 that have magnitudes corresponding to the results of multiplication and accumulation operations as applied to a matrix of conductance values programmed into the memristor crossbar array 201 and a column of voltage levels applied according to the input data 209.

For example, when an input voltage is applied on the wordline 261, the voltage generates currents flowing to the bitlines 241, 243, . . . , 245 through a row of memristors 211, 221, . . . , 231 respectively in the array 201. The contributions from the input voltage as applied on the wordline 261 to the currents in the bitlines 241, 243, . . . , 245 are proportional to conductance values of the row of memristors 211, 221, . . . , 231, The bitlines 241, 243, . . . , 245 sum the electric currents contributed to the bitlines 241, 243, . . . , 245 from the input voltages applied on the wordlines 261, . . . , 263, 265, . . . , 267. Thus, the currents in the bitlines 241, 243, . . . , 245 correspond to the summation of the multiplications of the memristor conductance values with the input voltages of the wordlines 261, . . . , 263, 265, . . . , 267 that represent the input data 209.

For example, the contributions of the input voltages on the wordlines 261, . . . , 263, 265, . . . , 267 to the bitline 241 are summed via the currents flowing from the wordlines 261, . . . , 263, 265, . . . , 267 through the memristors 211, . . . , 213, 215, . . . , 217 to the bitline 241; the contributions of the voltages on the wordlines 261, . . . , 263, 265, . . . , 267 to the bitline 243 are summed via the currents flowing from the wordlines 261, . . . , 263, 265, . . . , 267 through the memristors 221, . . . , 223, 225, . . . , 227 to the bitline 243; and the contributions of the voltages on the wordlines 261, . . . , 263, 265, . . ., 267 to the bitline 245 are summed via the currents flowing from the wordlines 261, . . . , 263, 265, . . . , 267 through the memristors 231, . . . , 233, 235, . . . , 237 to the bitline 245.

Thus, the memristor crossbar array 201 can be used to perform multiplication and accumulation operations.

For example, the current detectors 205 include analog to digital converter (ADCs) to measure the currents flowing through the bitlines 241, 243, . . . , 245. The measurement results of the current detectors 205 can be further operated upon (e.g., using a logic circuit) according to the quantized model 132.

In some implementations, the quantized model 132 includes the determination of whether the currents are above one or more thresholds. The current detectors 205 can include comparators to generate digital outputs of whether the currents on the bitlines 241, 243, . . . , 245 are above thresholds specified for the respective bitlines 241, 243, . . . , 245.

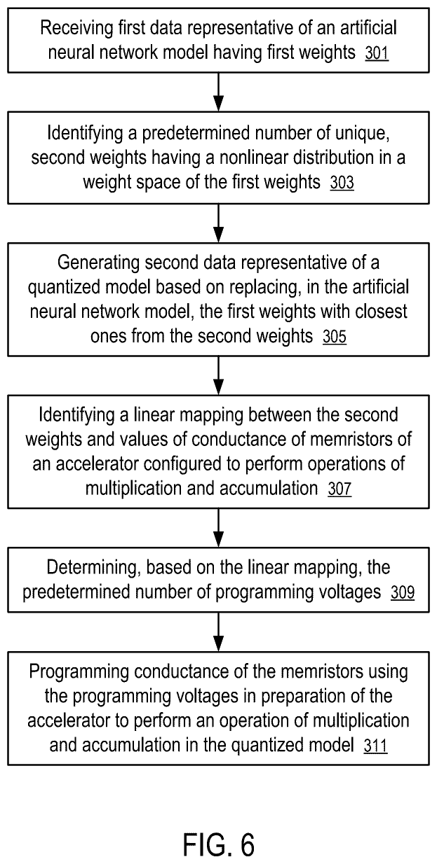

FIG. 6 shows a method of implementing the computations of an artificial neural network in an analog compute module according to one embodiment.

For example, the method of FIG. 6 can be implemented in a computing device having at least one processor (e.g., microprocessor) and a memory sub-system having a memristor crossbar array 201 usable to accelerate operations of multiplication and acceleration (e.g., as in FIG. 4 and FIG. 5). The method can be implemented using the techniques of FIG. 1, FIG. 2 and FIG. 3.

At block 301, the method includes receiving first data representative of an artificial neural network model 131 having first weights 133.

At block 303, the method includes identifying a predetermined number of unique, second weights (e.g., as in the representative weight list 135, such as W1, W2, . . . , W8 in FIG. 1) having a nonlinear distribution in a weight space of the first weights 133.

At block 305, the method includes generating second data representative of a quantized model 132 based on replacing, in the artificial neural network model 131, the first weights 133 with closest ones from the second weights (e.g., in the representative weight list 135).

At block 307, the method includes identifying a linear mapping 103 between the second weights (e.g., W1 to W8 in FIG. 1) and values of conductance of memristors of an accelerator configured to perform operations of multiplication and accumulation.

At block 309, the method includes determining, based on the linear mapping 103, the predetermined number of programming voltages (e.g., as in the programming voltage list 136, such as V1, V2, . . . , V8 in FIG. 1).

At block 311, the method includes programming conductance of the memristors (e.g., in memristors crossbar array 201) using the programming voltages (e.g., V1, V2, . . . , V8) in preparation of the accelerator (e.g., memristors crossbar array 201) to perform an operation of multiplication and accumulation in the quantized model 132.

For example, the method can further include: adjusting the nonlinear distribution and/or the linear mapping to improve an accuracy level of the quantized model 132 resulting from replacing the first weights 133 with closest ones from the second weights (e.g., in the weight list 135).

For example, the method can further include: dividing the weight space into: a lower range 111 having weights smaller than a first threshold 117; an upper range 115 having weights larger than a second threshold 119 larger than the first threshold 117; and a middle range 113 having weights between the first threshold 117 and the second threshold 119. The predetermined number of the second weights (e.g., in the list 135) can be allocated to the lower range, the middle range, and the upper range to control the allocation of rounding error precision during quantization 151.

For example, a gap between two adjacent ones of the second weights in the middle range 113 can be configured to be larger than any gap between two adjacent ones of the second weights in the lower range 111 and any gap between two adjacent ones of the second weights in the upper range 115. Thus, the rounding errors can be distributed more to the middle range 113 and to the upper range 115 and the lower range 111, since the weights in the upper range 115 and the lower range 111 can be more important to the artificial neural network model 131 than the weights in the middle range 113.

Optionally, within each of the middle range 113, the lower range 111, and the upper range 115, the second weights can be configured to be uniformly spaced for simplification, even though the second weights across the ranges 111, 113 and 115 are non-uniform and not evenly space. For example, the adjusting of the nonlinear distribution can be performed via adjusting the first threshold 117, or the second threshold 119, or both. Alternatively, the second weights can be non-uniformly distributed even within each of the middle range 113, the lower range 111, and the upper range 115.

For example, the method can further include: comparing first outputs of the quantized model 132 and second outputs of the artificial neural network model 131, responsive to a same set of inputs, to evaluate an accuracy level 139 of the quantized model 132. The distribution of locations of the representative weights (e.g., W1 to W8) in the weight space can be adjusted to improve or optimize the accuracy level 139. Optionally, the linear mapping 103 is also adjusted to improve or optimize the accuracy level 139.

For example, the method can further include: generating the first outputs of the quantized model 132 using a same computing device used to generate the second outputs of the artificial neural network model 131. The computation device can have an accuracy level in weight implementations that matches with the first weights 133 of the artificial neural network model 131.

Alternatively, different computing devices can be used to generate the first outputs of the quantized model 132 and the second outputs of the artificial neural network model 131. For example, the method can further include: generating the first outputs of the quantized model 132 using the accelerator (e.g., memristor crossbar array 201) having memristors programmed to have conductance using the programming voltages (e.g., in the list 136); and generating the second outputs of the artificial neural network model 131 without using the accelerator. Thus, the first outputs can be computed to include the rounding errors of the quantization 151 and the errors of the memristor conductance implementation of the second weights; and the second outputs can be computed to exclude the errors in implementing the first weights 133, such as the rounding errors of the quantization 151.

Optionally, the method can further include: training, using a training dataset of the artificial neural network model 131, the quantized model 132 having weights limited to be selected from the second weights (e.g., as in the weight list 135).

In general, a memory sub-system can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The memory sub-system can be installed in a computing system to accelerate multiplication and accumulation applied to data stored in the memory sub-system. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems. In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of the firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure.

The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving first data representative of an artificial neural network model having first weights;
identifying a predetermined number of unique, second weights having a nonlinear distribution in a weight space of the first weights;
generating second data representative of a quantized model based on replacing, in the artificial neural network model, the first weights with closest ones from the second weights;
identifying a linear mapping between the second weights and values of conductance of memristors of an accelerator configured to perform operations of multiplication and accumulation;
determining, based on the linear mapping, the predetermined number of programming voltages; and
programming conductance of the memristors using the programming voltages in preparation of the accelerator to perform an operation of multiplication and accumulation in the quantized model.

2. The method of claim 1, further comprising:
adjusting the nonlinear distribution to improve an accuracy level of the quantized model resulting from replacing the first weights with closest ones from the second weights.

3. The method of claim 2, further comprising:
adjusting the linear mapping to improve an accuracy level of the quantized model resulting from replacing the first weights with closest ones from the second weights.

4. The method of claim 3, further comprising:
dividing the weight space into:
a lower range having weights smaller than a first threshold;
an upper range having weights larger than a second threshold larger than the first threshold; and
a middle range having weights between the first threshold and the second threshold; and
allocating the predetermined number of the second weights to the lower range, the middle range, and the upper range.

5. The method of claim 4, wherein a gap between two adjacent ones of the second weights in the middle range is configured to be larger than a gap between two adjacent ones of the second weights in the lower range and a gap between two adjacent ones of the second weights in the upper range.

6. The method of claim 5, wherein within each of the middle range, the lower range, and the upper range, the second weights are configured to be uniformly spaced.

7. The method of claim 6, wherein the adjusting of the nonlinear distribution includes adjusting the first threshold, or the second threshold, or both.

8. The method of claim 7, further comprising:
comparing outputs of the quantized model and outputs of the artificial neural network model, responsive to a same set of inputs, to evaluate an accuracy level of the quantized model.

9. The method of claim 8, further comprising:
generating the outputs of the quantized model using a same computing device used to generate the outputs of the artificial neural network model.

10. The method of claim 8, further comprising:
generating the outputs of the quantized model using the accelerator having memristors programmed to have conductance using the programming voltages; and
generating the outputs of the artificial network model without using the accelerator having memristors programmed to have conductance using the programming voltages.

11. The method of claim 7, further comprising:
training, using a training dataset of the artificial neural network model, the quantized model having weights limited to be selected from the second weights.

12. A device, comprising:
a memory sub-system having a memristor crossbar array; and
a logic circuit configured to:
replace, in an artificial neural network model having first weights, the first weights with closest ones from a predetermined number of unique, second weights that are not evenly spaced in a weight space of the first weights;
determine, based on a linear mapping between the second weights and values of conductance of memristors in the memristor crossbar array, the predetermined number of programming voltages;
program conductance of the memristors using the programming voltages; and
generate first outputs of a quantized version of the artificial neural network model responsive to a set of inputs, based on the memristor crossbar array having the values of conductance in performing an operation of multiplication and accumulation.

13. The device of claim 12, wherein the logic circuit is further configured to:
generate second outputs of the artificial neural network model responsive to the set of inputs; and
compare the first outputs and the second outputs to evaluate an accuracy level of the quantized version.

14. The device of claim 13, wherein the logic circuit is further configured to:
adjust a distribution of the predetermined number of the second weights in the weight space to improve the accuracy level of the quantized version.

15. The device of claim 14, wherein the logic circuit is further configured to:
adjust the linear mapping to improve the accuracy level of the quantized version.

16. The device of claim 15, wherein the logic circuit includes a microprocessor configured via instructions.

17. A non-transitory computer storage medium storing instructions which, when executed in a computing device, cause the computing device to perform a method, comprising:
generating a quantized model from replacing, in an artificial neural network model having first weights, the first weights with closest ones from a predetermined number of unique, second weights having a non-uniform distribution in a weight space of the first weights;
determining a linear mapping between the second weights and values of conductance of memristors in a memristor crossbar array;
programming conductance of the memristors using programming voltages determined from the linear mapping; and
generating first outputs of a quantized model responsive to a set of inputs, based on the memristor crossbar array having the values of conductance in performing an operation of multiplication and accumulation.

18. The non-transitory computer storage medium of claim 17, wherein the method further comprises:
generating second outputs of the artificial neural network model responsive to the set of inputs; and
comparing the first outputs and the second outputs to evaluate an accuracy level of the quantized version.

19. The non-transitory computer storage medium of claim 18, wherein the method further comprises:
adjusting the non-uniform distribution to improve the accuracy level of the quantized version.

20. The non-transitory computer storage medium of claim 18, wherein the method further comprises:
adjusting the linear mapping to improve the accuracy level of the quantized version.
